(19) United States
(12) Patent Application Publication
(10) Pub. No.: US 2013/0299453 A1
(43) Pub. Date: Nov. 14, 2013

(54) METHOD FOR MAKING METAL PLATED GAS TURBINE ENGINE COMPONENTS

(71) Applicants: Benjamin Joseph Zimmerman, Enfield, CT (US); Curtis H. Riewe, Manchester, CT (US)

(72) Inventors: Benjamin Joseph Zimmerman, Enfield, CT (US); Curtis H. Riewe, Manchester, CT (US)

(73) Assignee: UNITED TECHNOLOGIES CORPORATION, Hartford, CT (US)

(21) Appl. No.: 13/470,676

(22) Filed: May 14, 2012

(51) Int. Cl. B32B 38/00; C25D 5/48; C25D 5/54

(52) U.S. Cl. 216/33; 156/150; 205/159

(57) ABSTRACT

A method for making a component for a gas turbine engine comprises forming a non-metal substrate having at least one metal receiving surface. A cathode is formed corresponding to a shape of the at least one metal receiving surface. The cathode is submerged into an ionic liquid plating solution. The solution comprises a source of metal cations and a first ionic liquid solvent. An electrical current is applied through the plating solution to the cathode, thereby depositing metal cations onto the cathode and forming an outer metal element The outer metal element is secured to the at least one metal receiving surface of the non-metal substrate.

### BACKGROUND

The application relates generally to methods of forming metal layers on non-metallic substrates and more specifically to methods for plating metal onto non-metallic substrates for manufacturing gas turbine engine components.

Aircraft and engine makers are under continuous pressure to reduce weight of their structural materials without unduly sacrificing performance and cost. Many parts are formed completely from metal because there is no cost-effective rapid, and/or safe method to provide a metal coating onto a nonmetallic substrate. Providing metal coatings onto nonmetallic aircraft engine components has previously been performed by plating using an electrolytic aqueous solution, often referred to as electrolytic deposition, or electroplating. Electroplating can be an expensive, difficult, and dangerous process using one or more of hot aqueous corrosive plating solutions, molten salts, or organic solvents, and is not suitable for many other plating and coating applications. For example, some plating materials like aluminum and titanium cannot be electroplated using aqueous solutions. The water will dissociate into hydrogen and oxygen ions at a voltage lower than what is necessary for the metal cation to reduce to its metallic state. In other cases, substrates like high strength steel are prone to hydrogen embrittlement, requiring special precautions when used with standard aqueous plating solutions.

Recent advances in ionic liquids have shown promise for applying metallic coatings in certain specialized applications. But problems have arisen with chemical and structural compatibility between many non-metallic substrates and the outer metal layer for structural or mechanical uses. The following describes several examples of compatible compounds for cold-section aerospace applications.

### SUMMARY

A method for making a component for a gas turbine engine comprises forming a non-metal substrate having at least one metal receiving surface. A cathode is formed corresponding to a shape of the at least one metal receiving surface. The cathode is submerged into an ionic liquid plating solution. The solution comprises a source of metal cations and a first ionic liquid solvent. An electrical current is applied through the plating solution to the cathode, thereby depositing metal cations onto the cathode and forming an outer metal element The outer metal element is secured to the at least one metal receiving surface of the non-metal substrate.

### BRIEF DESCRIPTION OF THE DRAWINGS

FIG. 1 is a schematic cross-section of a gas-turbine engine assembly.

FIG. 2A shows a perspective view of a fan blade for a gas-turbine engine.

FIG. 2B is a cross-section of the fan blade shown in FIG. 2A.

FIG. 2C is an exploded view of the blade cross-section shown in FIG. 2B.

FIG. 2D shows an alternative embodiment of the metal sheath in FIGS. 2A-2C.

FIG. 3A depicts a fan exit guide vane.

FIG. 3B is a cross-section of the fan exit guide vane from FIG. 3A

FIG. 4 is a cross-section of a gearbox for a gas-turbine engine including a gearbox with non-metal and metal elements.

FIG. 5 is a process chart of an ionic-liquid plating process for components of a gas turbine engine.

### DETAILED DESCRIPTION

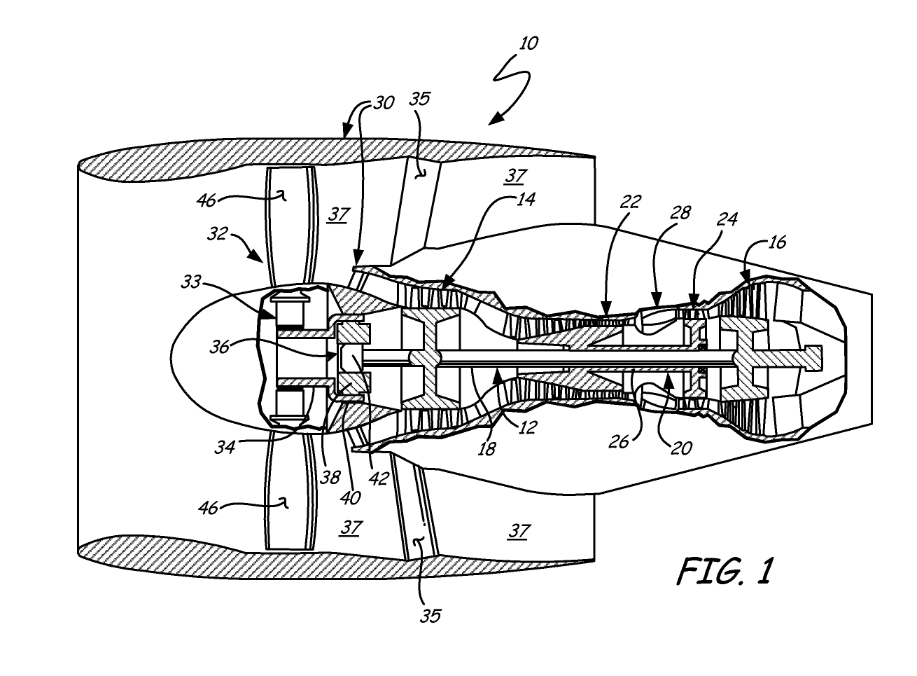

FIG. 1 includes gas turbine engine 10, low spool 12, low pressure compressor (LPC) 14, low pressure turbine (LPT) 16, low pressure shaft 18, high spool 20, high pressure compressor (HPC) 22, high pressure turbine (HPT) 24, high pressure shaft 26, combustor 28, nacelle 30, propulsion fan 32, fan rotor hub 33, fan shaft 34, fan exit guide vanes 35, fan drive gear system 36, fan duct 37, ring gear 38, sun gear 40, planetary gear 42, accessory gearbox 44, and fan blades 46.

FIG. 1 is a cross-sectional schematic view of gas turbine engine 10, in a two-spool turbofan configuration for use as a propulsion engine. In this particular example, low spool 12 includes low pressure compressor (LPC) 14 and low pressure turbine (LPT) 16, rotationally coupled via low pressure shaft 18. High spool 20 includes high pressure compressor (HPC) 22 and high pressure turbine (HPT) 24, rotationally coupled via high pressure shaft 26. Combustor 28 is arranged in flow series between high pressure compressor 22 and high pressure turbine 24, with low and high spools 12 and 20 coaxially oriented about the center of gas turbine engine 10.

Nacelle 30 is coaxially oriented about the forward end of the power core extending generally between propulsion fan 32 and fan exit guide vanes 35. Fan shaft 34 is rotationally coupled to fan 32 having a plurality of fan blades 46 around hub 33, generating propulsive flow through fan duct 37. In advanced engine designs, fan drive gear system 36 couples fan shaft 34 to low spool 12, with respective ring, sun, star and planetary gear mechanisms 38, 40 and 42 providing independent fan speed control for reduced noise and improved operating efficiency. Accessory gearbox 44 is disposed at the turbine end of low spool 12 adjacent the outlet of the power core and duct 37. Gearbox 44 converts turbine shaft power to a speed more suitable for driving electric and/or hydraulic generators (not shown in FIG. 1). In certain embodiments, accessory gearbox 44 is integral with one or both types of generators.

Some engine 10 components can be manufactured by combining at least one metal element with a non-metal substrate. In existing processes, those metal elements are often formed by electrolytically plating the metal element either directly on the non-metal substrate or separately onto dedicated tooling. Separately formed metal elements can then be bonded to the non-metal element. Other engine parts are currently manufactured completely from metal but would benefit from weight reduction by substituting a non-metal composition for one or more less critical portions of the part. Only certain non-metal substrates and/or metal plating elements can withstand the harsh plating conditions of existing processes. For many such parts, a satisfactory method has not been available to replace all-metal components with components having one or more non-metal elements.

It will be understood that the vast majority of standard ionic (salt) compounds have very high melting points, significantly limiting their use in metal plating due to the required safety precautions and high energy consumption. Such temperatures would destroy most non-metal substrates. And in traditional electrolytic deposition, harsh, usually acidic, aqueous plating solutions are used, which presents not only safety concerns, but also complicates storage and disposal of used solutions.

In contrast, an ionic liquid plating process can be used in both situations at relatively low temperatures and without the use of large volumes of dangerous chemicals or expensive deposition equipment. Other metals such as titanium can be plated via ionic liquid solutions that cannot otherwise be readily deposited electrolytically from traditional aqueous plating solutions. An ionic liquid plating solution for gas turbine engine components can be produced by dissolving a metal salt, such as an anhydrous metal-halide salt into an ionic liquid solvent. Ionic liquid plating solutions can be characterized by combining the metal-halide salt with a compatible molten metal salt having a relatively low melting point, typically below about 100° C. (212° F.). Many ionic liquid solvents achieve this low melting point due to the presence of discrete ions having sufficiently large ionic nuclei so as to provide a very low lattice energy, as well as high electrochemical potentials. Other molten salts used as ionic liquid solvents are a eutectic mixture of two or more compounds allowing for dissolution of the metal halide salt. In either case, the metal ion is deposited from the anhydrous halide salt and the plating solution is maintained in a very low temperature, relatively inert state. At the same time, it would be desirable to reduce the waste stream surrounding used conventional electrolytic plating solutions and replace those with less harmful and toxic ionic liquid solvents.

The following figures show several illustrative examples of components having at least one non-metal element and at least one metal element, where the metal element can be made according to an ionic liquid plating process.

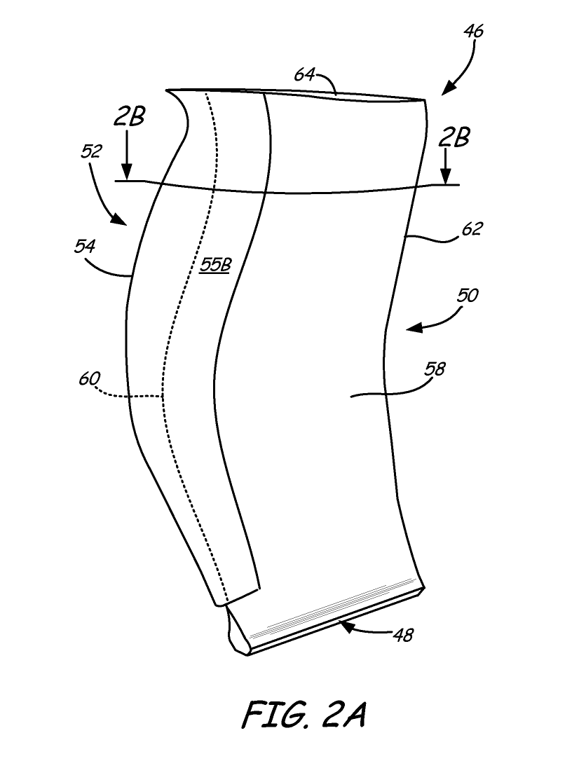

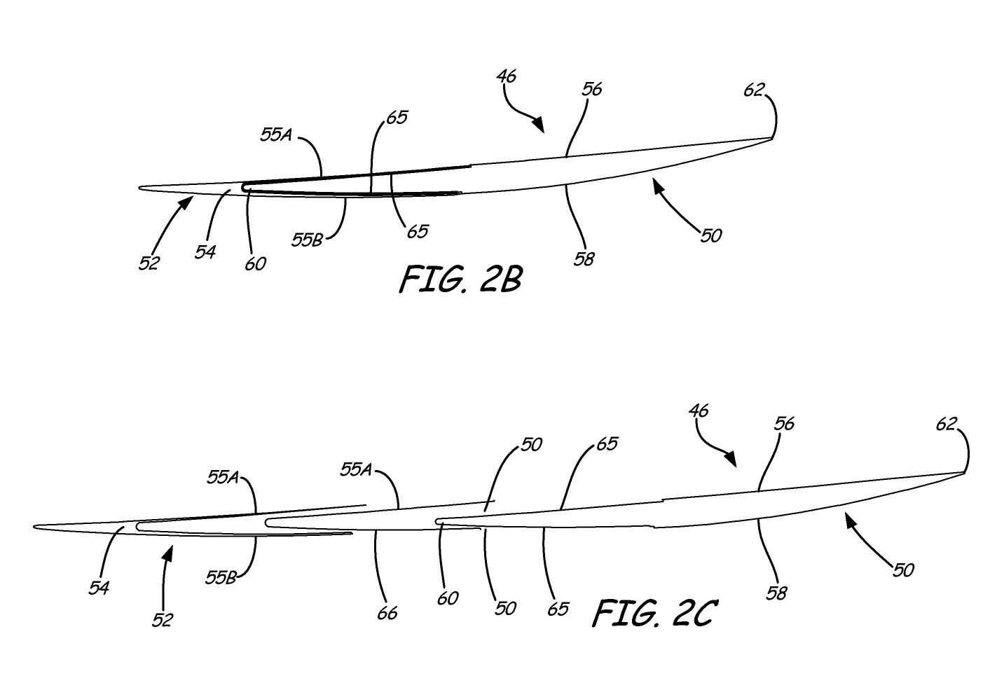

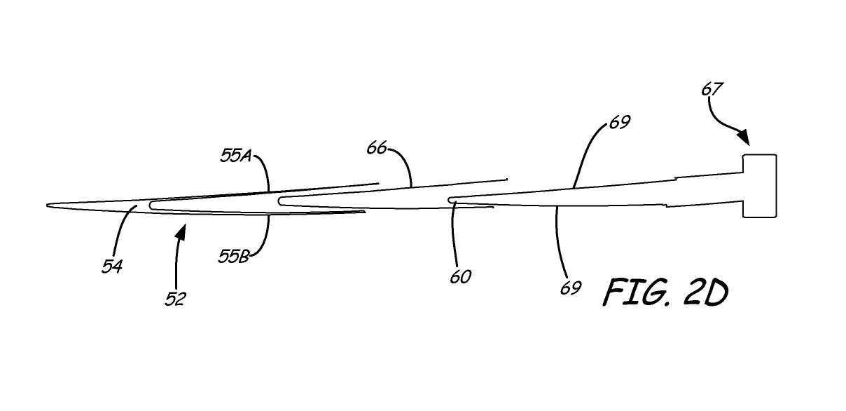

FIG. 2A shows fan blade 46. FIG. 2B is a cross-section of blade 46 taken across line 2B in FIG. 2A. FIG. 2C is an exploded view of the cross-section shown in FIG. 2B. In FIGS. 2A-2C, blade 46 includes root portion 48, composite blade body 50, leading edge metal sheath 52, metal sheath forward edge 54, flanks 55A, 55B, pressure surface 56, suction surface 58, blade leading edge 60, blade trailing edge 62, tip region 64, leading edge sheath receiving surfaces 65, and cathode layer 66.

Fan blade 46 is one of several identical blades 46 operatively attached to hub 33 (shown in FIG. 1) at root portion 48. Fan blade 46 includes a non-metal element, namely composite blade body 50. In this example, composite blade body 50 has a carbon-fiber reinforced body formed over a rigid inner spar portion (not shown). The carbon fiber reinforces various light weight non-metal binder materials such as an epoxy, a bismaleimide, or a polyimide forming the outer composite surface of body 50. The spar portion (not shown) of a composite blade provides mechanical strength to blade body 50, and typically extends spanwise from root portion 48. However, composite blade body 50 is not limited to this variety and can be made from any other suitable non-metal composite structure.

Leading edge metal sheath 52 includes sheath forward edge 54 to increase resiliency and resist the effects of foreign object damage (FOD) and domestic object damage (DOD). Leading edge sheath 52 also has two flanks 55A, 55B extending generally chordwise and covering portions of pressure surface 56 and suction surface 58 as well as blade leading edge 60. Flanks 55A, 55B extend from metal sheath forward edge 54 toward blade trailing edge 62 to resist operational bending stresses and to minimize FOD and DOD events. Additionally or alternatively, leading edge sheath 52 may also have one or more similar flanks extending over at least part of tip region 64.

In one embodiment of the plating process, leading edge sheath 52 is formed directly on receiving surfaces 65 proximate blade leading edge 60. Receiving surfaces 65 can be prepared to receive metal sheath 52 either directly or indirectly from the ionic liquid plating solution. Preparation of leading edge receiving surfaces can include chemical and/or physical etching. Preparation also can include metalizing the surface to make it conductive, forming cathode layer 66 directly on receiving surfaces 65. This step can be performed by any suitable electrolytic or thin-film deposition technique. In one example, cathode layer 66 is laid down by thin-film deposition of platinum. Other surfaces of composite body 50 may be masked prior to the preliminary metalization step in order to further direct deposition of cathode layer 66 onto the correct receiving surfaces 65. Body 50 may also be masked in preparation for the subsequent ionic liquid plating step for forming metal leading edge sheath 52.

In this embodiment, after substrate preparation, sheath 52 plated directly over receiving surfaces 65 by submerging surfaces 65 to be plated into the ionic liquid plating solution. One example method for depositing the titanium sheath 52 follows. A titanium halide, such as titanium (IV) chloride (TiCl₄) or titanium (IV) fluoride (TiF₄), is dissolved into an appropriate ionic liquid solvent existing in molten salt form. In one example, the ionic liquid solvent can be a mixture of 1-butyl-3-methyl-imidazolium and bis-(trifluoromethylsulfonyl) amide (BMIM Tf2N). Alternatively, the solvent can include a form of 1,1-dialkylpyrrolidinium.

In the presence of the chosen ionic liquid solvent, titanium (Ti⁴⁺) cations readily dissociate from the halide anions (Cl⁻ or F). Appropriate voltage is then applied through the solution between an anode (not shown) and cathode 66. This voltage can be on the order of 3.5 V-4.3 V depending on the particular concentration of Ti⁴⁺ ions, solution temperature, and cathode surface energies. Once at least a portion of sheath 52 has reached an appropriate thickness on one or more receiving surfaces 65, blade 46 is then removed from the plating solution. It will also be apparent that the plating process can be staged to mask certain receiving surfaces 65 after partial plating, thereby achieving different desired thicknesses on different receiving surfaces 65. In the example of blade 46, sheath 52 has relatively thin flanks 55A, 55B. Once they reach sufficient thickness, the process can be paused, and a masking material applied such that additional plating metal will no longer accumulate on flanks 55A, 55B. During a second ionic liquid plating stage, metal will continue accumulating and building up the thickness of sheath 52 around forward edge 54. Alternatively, sheath 52 can be plated to uniform thickness before subsequently being machined into the correct airfoil leading edge shape.

FIG. 2D shows an exploded view of an alternative embodiment of making sheath 52. Sheath 52 is manufactured separately over specialized tooling 67 with tooling receiving surfaces 69 corresponding to the at least one receiving surface 65 shown in FIGS. 2A-2C. Rather than being directly formed on body 50, a cathodic metal layer 66 is formed on receiving surfaces 69 of tooling 67 having a shape similar or identical to airfoil receiving surfaces 65 (shown in FIG. 2C). Cathode 66 can include a thin platinum layer, formed for example via electrolytic deposition from a platinum chloride bath. The tooling and cathodic layer are then cleaned and submerged in the ionic liquid plating solution and processed as described in the preceding paragraph. Once sheath 52 is formed on tooling 67, both are removed from the ionic liquid plating bath. Sheath 52 is then separated from tooling 67, such as by a chemical solution preferentially dissolving the cathodic layer 66, or a temporary bonding layer holding cathode 66 to tooling 67. Sheath 52 is then secured to receiving surfaces 65 of blade body 50 by any suitable means including but not limited to epoxy- or urethane-based adhesives.

Other related ionic liquid solvents may be identified that will also suitably dissolve titanium halides or other simple titanium salts. Other combinations of ionic liquid solvents and metal salts may be provided that allow the dissolved titanium to supplemented with other alloying elements such as aluminum or vanadium in the plating solution.

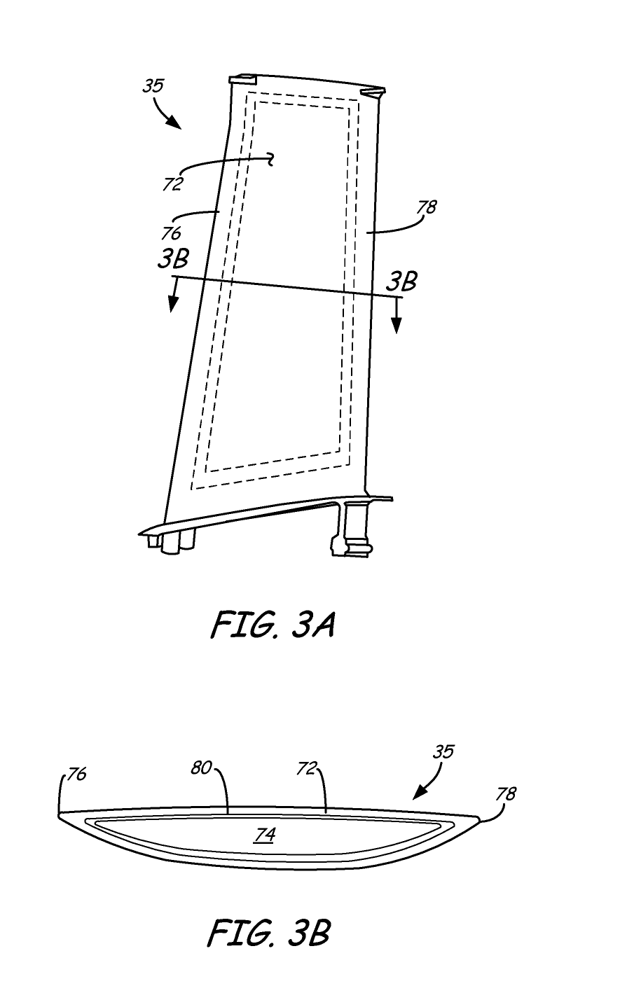

FIG. 3A includes fan exit guide vane 35, titanium layer 72, non-metal substrate 74, leading edge 76, trailing edge 78, and cathode 80. FIG. 3B is a cross-section of vane 35. FIG. 3A shows another use for titanium ionic liquid plating in a gas turbine engine. Similar to fan blade 46 (shown in FIGS. 2A-2C), an ionic liquid plating process can be adapted to fabricate fan exit guide vanes (FEGV's) 35, which are disposed circumferentially around the power core of engine 10 as shown in FIG. 1. FEGV's 35 direct the air drawn in by fan rotor 32 through fan duct 37 in nacelle 30, also shown in FIG. 1.

In this example, FEGV 35 can be fabricated with a non-metal substrate at the center and a metal covering entirely therearound. Weight can be saved over traditional metal FEGV's by replacing a substantial portion of the airfoil with a lighter weight non-metal substrate. In these alternative examples, the entire vane 35 is plated with titanium layer 72 using the above ionic liquid plating process, rather than just the area proximate leading edge 76. Prior to plating titanium element 72 cathode 80 is first provided over the entire non-metal substrate 74, including trailing edge 78. As before, cathode 80 can be formed using electrolytic or thin-film deposition of platinum or another suitable cathodic material either directly on substrate 74 or can alternatively be formed on separate tooling (not shown) corresponding to substrate 74. Cathode 80 can optionally be removed either mechanically or chemically from titanium element 72 prior to securing titanium element 72 to substrate 74. When formed on separate tooling, titanium element 72 is then cleaned and bonded to non-metal substrate 74 as one or more outer metal elements.

FEGV 35 must be able withstand the buffeting and stresses from the bypass flow caused by propulsion fan rotor 32? (shown in FIG. 1) and must remain resistant to FOD and DOD events. In many cases, they also provide structural support for nacelle 30 (shown in FIG. 1). Thus the non-metal substrate 74 may include a composite similar to that used for fan blade 46 above (shown in FIGS. 2A-2C). Alternatively, where the strength and resiliency requirements are not as strict, the composite may be replaced with a high temperature thermoplastic resin like polyether ether ketone (PEEK).

In one example, the above plating process described with respect to FIGS. 3A-3B can additionally or alternatively be implemented and adapted to manufacture a compressor stator vane, disposed in LPC section 14 (shown in FIG. 1). LPC stator vanes experience relatively low inlet temperatures and thus a non-metal substrate such as a composite or resilient thermoplastic such as PEEK is suitable for many LPC vanes Like FEGV 35, LPC vanes include non-metal substrate 74 with titanium layer 72 formed according to variations on the above method.

For airfoil components, the lower density of the composites and/or thermoplastics saves overall weight in the engine, improving efficiency particularly when applied to rotary parts. The ionic liquid plating process can also be used in conjunction with protective coatings. Once the plated metal element is formed and secured to the receiving surface(s) of the substrate, a thermal, abradable, or other suitable coating can be added to the outer metal element(s). It will be appreciated that in these embodiments, the thickness of the metal element(s) will be sufficient to provide diffusion or bonding between the coating and the metal. In one example, the use of thermal barrier coatings can increase temperature resistance of the component, particularly the non-metal substrate, making it more suitable for higher temperature regions of the engine. Other coatings including erosion-resistant compounds, corrosion-resistant compounds, abradable coatings, and bond coatings can also be formed on the metal element(s).

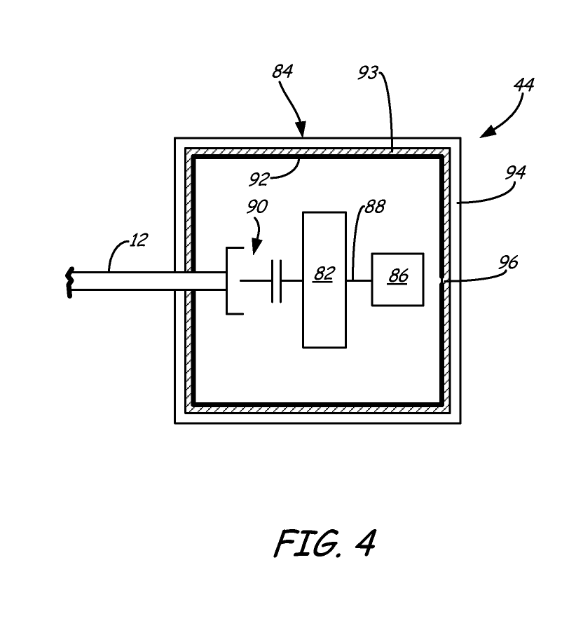

FIG. 4 includes accessory gearbox 44 with engine shaft 12, inner gear housing 82, outer gearbox housing 84, generator 86, internal shaft 88, clutch 90, non-metal housing layer 92, cathode 93, metal housing layer 94, and union 96. In addition to the airfoils described above, an ionic liquid plating process can be adapted to fabricate ancillary components with a non-metal substrate and one or more outer metal elements. In FIG. 4, accessory gearbox 44 includes inner gear housing 82 within outer gearbox housing 84. Engine shaft 12 drives generator 86 via internal shaft 88 and clutch 90. Inner gear housing 82 contains several reducing gears (not shown) for operating generator 86, which may be an electrical or hydraulic generator.

Currently accessory gearboxes are manufactured solely from metal such as aluminum or one of its alloys, which have historically provided a balance between strength and weight. However, in many applications, accessory gearboxes experience little in the way of external stresses and often have external shielding protecting them from engine heat, making them good candidates for weight reduction with non-metal elements. Thus in certain embodiments, outer gearbox housing 84 is manufactured with a high strength, temperature resistant resin substrate layer such as PEEK forming non-metal housing layer 92, and then provided with metal layer 94 such as aluminum via a variation on the ionic liquid plating process. Since the internal volume of gearbox 44 is typically required to be accessible for servicing, outer housing 84 has at least two parts joined at union 96. Thus housing 84 can be formed with individual parts each made by plating non-metal substrate 92 with metal layer 94.

In this embodiment, after substrate preparation, metal layer 94 is formed by submerging surfaces into an ionic liquid plating solution. When metal layer 94 is aluminum, an aluminum halide such as AlCl₃ is dissolved into an appropriate ionic liquid solvent existing in molten salt form. In certain embodiments, the ionic liquid is a form of methylimidazolium chloride. In certain of those embodiments, the ionic liquid comprises at least one of: 1-ethyl-3-methylimidazolium chloride, 1-butyl-3-methylimidazolium chloride, 1-butyl-1-methylpyrrolidinium bis(trifluoromethylsulfonyl)amide, 1-ethyl-3-methylimidazolium bis(trifluoromethylsulfonyl)amide, trihexyl-tetraadecyl phosphonium bis(trifluoromethylsulfonyl)amide, and mixtures thereof.

In the presence of the chosen ionic liquid solvent, aluminum cations (Al³⁺) readily dissociate from the halide anions, here chloride (co. Appropriate voltage is then applied through the solution between an anode (not shown) and cathode 66. This voltage can be on the order of 3.0-3.6V depending on the particular concentration of Al³⁺ cations, solution temperature, and cathode surface energies. Once metal layer 94 has reached an appropriate thickness, housing 84 is then removed from the plating solution.

The above ionic liquid solvents can also be used for plating nickel-based elements onto gas turbine engine components using nickel halides such as nickel (II) chloride (NiCl₂). Similar to the titanium and aluminum halides, the nickel halide is dissolved in the ionic liquid solvent comprising a form of methylimidazolium chloride. In certain of those embodiments, the ionic liquid comprises at least one of: 1-ethyl-3-methylimidazolium chloride, 1-butyl-3-methylimidazolium chloride, 1-butyl-1-methylpyrrolidinium bis(trifluoromethylsulfonyl)amide, 1-ethyl-3-methylimidazolium bis(trifluoromethylsulfonyl)amide, trihexyl-tetraadecyl phosphonium bis(trifluoromethylsulfonyl)amide, and mixtures thereof.

Accessory gearboxes 44 are one example of components where non-metal substrate 92 can be fabricated using a rapid prototyping or rapid manufacturing process. Such processes are useful for relatively small scale production lines for parts that also require high precision shapes. Gearboxes 44 benefit from such rapid manufacturing processes because they could be conformed closely to internal generator and gear elements, which may vary from engine to engine based on customer demands. This provides the additional benefits of reducing the footprint of the gearbox in each engine 10 as well as providing more room in the area surrounding the power core. This space can be used for other ancillary components or to optimize the shape or size of the exit flow path. Thus in this alternative embodiment, non-metal substrate 92 is any photo-curable resin suitable for use in a stereolithography or other rapid prototyping machine.

While accessory gearbox 44 is shown as an illustrative example, it will be understood that other gearbox applications for gas turbine engines can also benefit from this process. In an alternative example, fan drive gear system 36 includes a housing for retaining gears 38, 40, 42 (shown in FIG. 1). In another alternative example, gearbox 44 can mate one or both of an electric or hydraulic generator to an auxiliary power unit (APU) rather than to a propulsion engine. The above process can be readily adapted to gearbox housings for these and other engine applications.

It will also be noted that the ionic liquid plating process can be adapted to other rapid prototyping processes not directly used in a gas turbine engine. For example, investment casting molds can be created directly from a digital design file using a rapid prototyping apparatus. After manipulation of the photopolymer into a suitable non-metal substrate shape, the mold can be formed by utilizing the ionic liquid plating process, forming an outer refractory element on the mold surfaces used to retain the molten casting metal.

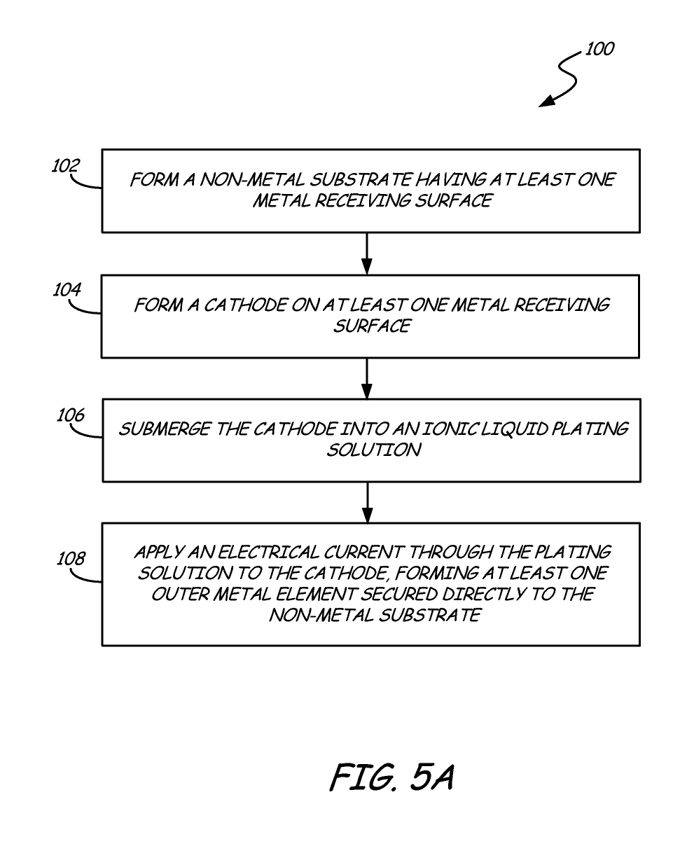

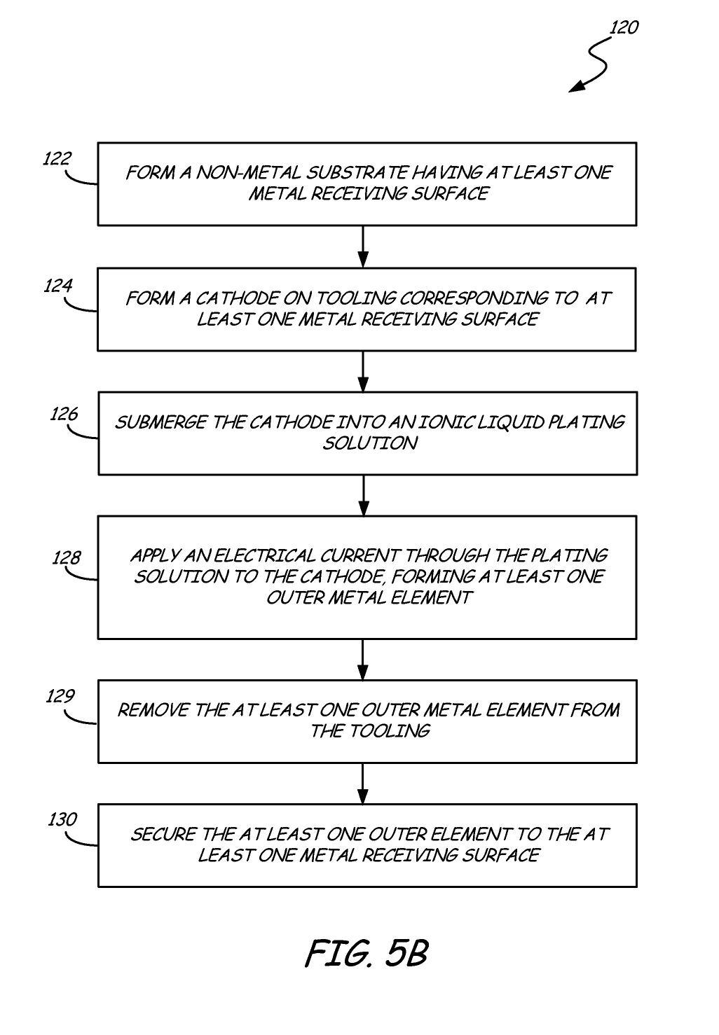

FIG. 5A shows a simplified process chart summarizing one example method 100 for an ionic liquid plating process for components of a gas turbine engine assembly. At step 102, a non-metal substrate is formed generally into a shape of the component with at least one metal receiving surface. Step 104 includes forming a cathode directly on the at least one metal receiving surface. As noted previously, the cathode can be formed directly on the at least one metal receiving surface, or can be formed onto tooling and removed after formation of the outer metal element. Examples of cathode formation are described above with respect to FIGS. 1-4.

Step 106 describes forming the metal element on the cathode by submerging the cathode into an ionic liquid plating solution. As described above, the solution comprises a source of metal cations and a first ionic liquid solvent compatible with the source of metal cations. The metal cations can comprise one or more of nickel, aluminum, and titanium. Next, step 108 shows an electrical current applied through the plating solution to the cathode, thereby depositing metal cations onto the cathode and forming an outer metal element. The outer metal element is secured to the at least one metal receiving surface of the non-metal substrate. If produced separately such as by using separate tooling, the cathode may be removed mechanically or chemically from the metal element. In some instances, the metal element is removed from the tooling by chemically dissolving the cathode material.

FIG. 5B shows a simplified process chart summarizing an alternative example method 120 for an ionic liquid plating process for components of a gas turbine engine assembly. At step 122, non-metal substrate is formed into a shape of the component with at least one metal receiving surface. Step 124 includes forming a cathode onto tooling corresponding to a shape of the at least one metal receiving surface. Examples of cathode formation are described above with respect to FIGS. 1-4. At step 126, the cathode is submerged into the ionic liquid plating solution (described above), after which step 128 includes applying the electrical current through the solution to the cathode. Process 120 concludes with steps 129 and 130 respectively including removing the at least one outer metal element from the tooling and securing it onto the at least one metal receiving surface of the non-metal element. The outer metal element can be secured adhesively or by other suitable means as described above.

Embodiments of this process can improve employee and equipment safety due to the reduced toxicity and exposure to harmful vapors as compared to traditional aqueous or organic solvents used in electrolytic deposition. Some embodiments described above require only a relatively thin electroplated layer on the substrate in order to establish a cathode surface, while other components can be formed over tooling that includes a form or template for a cathode surface. The cathode is then separated from the tooling and fitted to the at least one prepared surface of the non-metal substrate and then secured via epoxy or other adhesive. Reduction potentials of metals in an ionic liquid are also lower as compared to aqueous solutions, reducing the energy required during the coating process. Furthermore, for some metals, such chromium (Cr), a much higher percentage of the energy applied to the plating cell actual results in the deposition of metal. This value can be up to about 90%. In contrast, for standard electroplating, energy utilization is only about 15% since much of the applied electric current is consumed in the dissociation of water into hydrogen and oxygen ions)

Thus the process offers the opportunity to add to the quantity of production components utilizing a lighter weight substrate with the surface features and strength of a metal coating. Replacing current metal production parts with metal coated resin or composite substrates will significantly reduce engine weight, particularly for those components with relatively large bulk but that require less in terms of strength, corrosion resistance, and/or temperature resistance

The above examples have been described with respect to individual metal elements. It will be appreciated that the invention is not limited to pure or relatively pure metal elements. Thus the process is equally suitable and adaptable to protecting and strengthening gas turbine engine components with alloys of the above described metals. In some examples, a nano-scale alloy coating can be produced by co-deposition of multiple metals using one or more ionic liquid plating solutions.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Discussion of Possible Embodiments

The following are non-exclusive descriptions of possible embodiments of the present invention.

A method for making a component for a gas turbine engine comprises forming a non-metal substrate having at least one metal receiving surface. A cathode is formed corresponding to a shape of the at least one metal receiving surface. The cathode is submerged into an ionic liquid plating solution. The solution comprises a source of metal cations and a first ionic liquid solvent. An electrical current is applied through the plating solution to the cathode, thereby depositing metal cations onto the cathode and forming an outer metal element The outer metal element is secured to the at least one metal receiving surface of the non-metal substrate.

The method of the preceding paragraph can optionally include, additionally and/or alternatively, any one or more of the following steps, features, configurations and/or additional components:

the securing step is performed prior to the submerging step;

the cathode is secured to the at least one metal receiving surface of non-metal substrate by electrolytic deposition;

the cathode is secured to the at least one metal receiving surface by thin-film deposition;

the securing step is performed after the applying step;

the method further comprises the step of removing the cathode from the metal element prior to the securing step;

the securing step includes adhesively securing the outer metal element to the at least one metal receiving surface;

the method further comprises the step of etching the at least one metal receiving surface prior to adhesively securing the outer metal element to the at least one metal receiving surface;

the method further comprises the step of etching the at least one metal receiving surface prior to the cathode forming step;

the component includes an airfoil portion;

the component is selected from one of a fan exit guide vane, a low pressure compressor vane, and a fan blade;

the component is a gearbox housing;

the non-metal substrate is one of an organic matrix composite, a thermoplastic, or a photopolymer;

the non-metal substrate is a carbon-fiber reinforced composite material with a binder selected from one of: epoxy, bismaleimide, or polyimide;

the non-metal substrate is a polyester ester ketone (PEEK) thermoplastic;

the non-metal substrate is a photopolymer, and the forming step includes use of a rapid prototyping apparatus;

the metal cations comprise titanium (Ti⁴⁺) cations;

titanium chloride (TiCl₄) is a source of the titanium (Ti⁴⁺) cations;

the first ionic liquid solvent comprises at least one of: 1-butyl-3-methyl-imidazolium, bis-(trifluoromethylsulfonyl)amide, and a form of 1-dialkylpyrrolidinium;

the metal cations comprise aluminum (Al³⁺) cations;

aluminum chloride (AlCl₃) is a source of the aluminum (Al³⁺) ions;

the first ionic liquid solvent comprises methylimidazolium chloride;

the first ionic liquid solvent comprises at least one of: 1-ethyl-3-methylimidazolium chloride, 1-butyl-3-methylimidazolium chloride, 1-butyl-1-methyl-pyrrolidinium bis(trifluoromethylsulfonyl)amide, 1-ethyl-3-methylimidazolium bis(trifluoromethylsulfonyl)amide, trihexyl-tetradecyl phosphonium bis(trifluoromethylsulfonyl)amide, and mixtures thereof;

the metal cations comprise nickel (Ni²⁺) cations;

the ionic liquid comprises at least one of: 1-ethyl-3-methylimidazolium chloride, 1-butyl-3-methylimidazolium chloride, 1-butyl-1-methylpyrrolidinium bis(trifluoromethylsulfonyl)amide, 1-ethyl-3-methylimidazolium bis(trifluoromethylsulfonyl)amide, trihexyl-tetraadecyl phosphonium bis(trifluoromethylsulfonyl)amide, and mixtures thereof;

the method further comprises the step of applying a protective coating to at least one outer surface of the outer metal element.

1. A method for making a component for a gas turbine engine, the method comprising:
forming a non-metal substrate having at least one metal receiving surface;
forming a cathode corresponding to a shape of the at least one metal receiving surface;
submerging the cathode into an ionic liquid plating solution, the solution comprising a source of metal cations and a first ionic liquid solvent;
applying an electrical current through the plating solution to the cathode, thereby depositing metal cations onto the cathode and forming an outer metal element; and
securing the outer metal element to the at least one metal receiving surface of the non-metal substrate.

2. The method of claim 1, wherein the securing step is performed prior to the submerging step.

3. The method of claim 2, wherein the cathode is secured to the at least one metal receiving surface of non-metal substrate by electrolytic deposition.

4. The method of claim 2, wherein the cathode is secured to the at least one metal receiving surface by thin-film deposition.

5. The method of claim 1, wherein the securing step is performed after the applying step.

6. The method of claim 5, further comprising the step of removing the cathode from the metal element prior to the securing step.

7. The method of claim 5, wherein the securing step includes adhesively securing the outer metal element to the at least one metal receiving surface.

8. The method of claim 7, further comprising the step of etching the at least one metal receiving surface prior to adhesively securing the outer metal element to the at least one metal receiving surface.

9. The method of claim 1, further comprising the step of etching the at least one metal receiving surface prior to the cathode forming step.

10. The method of claim 1, wherein the component includes an airfoil portion.

11. The method of claim 10, wherein the component is selected from one of a fan exit guide vane, a low pressure compressor vane, and a fan blade.

12. The method of claim 1, wherein the component is a gearbox housing.

13. The method of claim 1, wherein the non-metal substrate is one of an organic matrix composite, a thermoplastic, or a photopolymer.

14. The method of claim 13, wherein the non-metal substrate is a carbon-fiber reinforced composite material with a binder selected from one of: epoxy, bismaleimide, or polyimide.

15. The method of claim 13, wherein the non-metal substrate is a polyester ester ketone (PEEK) thermoplastic.

16. The method of claim 13, wherein the non-metal substrate is a photopolymer, and the forming step includes use of a rapid prototyping apparatus.

17. The method of claim 1, wherein the metal cations comprise titanium (Ti⁴⁺) cations.

18. The method of claim 17, wherein titanium chloride (TiCl₄) is a source of the titanium (Ti⁴⁺) cations.

19. The method of claim 17, wherein the first ionic liquid solvent comprises at least one of: 1-butyl-3-methyl-imidazolium, bis-(trifluoromethylsulfonyl)amide, and a form of 1-dialkylpyrrolidinium.

20. The method of claim 1, wherein the metal cations comprise aluminum (Al³⁺) cations.

21. The method of claim 20, wherein aluminum chloride (AlCl₃) is a source of the aluminum (Al³⁺) ions.

22. The method of claim 20, wherein the first ionic liquid solvent comprises methylimidazolium chloride.

23. The method of claim 20, wherein the first ionic liquid solvent comprises at least one of: 1-ethyl-3-methylimidazolium chloride, 1-butyl-3-methylimidazolium chloride, 1-butyl-1-methylpyrrolidinium bis(trifluoromethylsulfonyl)amide, 1-ethyl-3-methylimidazolium bis(trifluoromethylsulfonyl)amide, trihexyl-tetradecyl phosphonium bis(trifluoromethylsulfonyl)amide, and mixtures thereof.

24. The method of claim 1, wherein the metal cations comprise nickel (Ni²⁺) cations.

25. The method of claim 1, wherein the first ionic liquid solvent comprises at least one of: 1-ethyl-3-methylimidazolium chloride, 1-butyl-3-methylimidazolium chloride, 1-butyl-1-methylpyrrolidinium bis(trifluoromethylsulfonyl) amide, 1-ethyl-3-methylimidazolium bis(trifluoromethylsulfonyl)amide, trihexyl-tetraadecyl phosphonium bis(trifluoromethylsulfonyl)amide, and mixtures thereof.

26. The method of claim 1, further comprising the step of applying a protective coating to at least one outer surface of the outer metal element.
